(19) United States
(12) Patent Application Publication
(10) Pub. No.: US 2025/0130085 A1
(43) Pub. Date: Apr. 24, 2025

(54) BUBBLE THERMOGRAPHY VELOCIMETRY FOR LARGE SCALE FLOW FIELD MEASUREMENT

(71) Applicant: Continuum Dynamics, Inc., Ewing, NJ (US)

(72) Inventor: Liuyang Ding, Princeton, NJ (US)

(73) Assignee: Continuum Dynamics, Inc., Ewing, NJ (US)

(21) Appl. No.: 18/921,257

(22) Filed: Oct. 21, 2024

Related U.S. Application Data
(60) Provisional application No. 63/591,573, filed on Oct. 19, 2023.

(51) Int. Cl. G01F 1/7086

(52) U.S. Cl. CPC G01F 1/7086

(57) ABSTRACT

Flow characteristics of a three-dimensional fluid flow are quantified by bubble thermography velocimetry (BTV) in which large numbers of bubbles buoyant in the fluid and having a predetermined size and temperature are introduced into in the fluid flow while long wavelength infrared camera (LWIR) cameras record the positions over time of individual bubbles. In one application the fluid is air and the bubbles are soap bubbles, and the velocity, acceleration and direction of individual bubbles carried by wind through a target area of interest are derived from the position of each bubble at predetermined time intervals for environmental analyses such as weather and climate modeling, urban dispersion studies, building wind load analyses, and the like. BTV defines each bubble's path and velocity vectors in three dimensions that produce richer data than known flow analysis techniques by tracking the bubbles over larger scales at correspondingly higher spatial and velocity resolutions.

### CROSS-REFERENCE TO RELATED APPLICATION

This application claims the benefit of U.S. provisional application No. 63/591,573, filed Oct. 19, 2023, the entire contents of which are incorporated by reference as part of the present disclosure as if set out in full herein. It will be referred to as “the '537 provisional application.”

### BACKGROUND

The United Nations reported in 2018 that 55% of the world's population lives in urban areas, and projected that the percentage will be almost 70% by 2050. “World Urbanization Prospects: The 2018 Revision, United Nations Department of Economic and Social Affairs,” https://population.un.org/wup/publications/Files/WUP2018-Report.pdf, pages 1-2. With such extreme size and density, urban populations are vulnerable to extreme weather events and severe air pollution, and will continue to have an increasingly significant impact on global climate change. Efforts continue to improve the ability to understand, monitor and predict urban atmospheric processes and their interactions with the climate on regional and global scales. Those processes usually exhibit strong spatial and temporal variations, encompass a wide range of scales, and are sensitive to human activities. They pose a major challenge to parameterizations in weather and climate models, especially in urban environments.

Weather and climate models require quantifying environmental factors (temperature, humidity, concentrations of pollutants, trace gases, etc.), and how they are distributed in various settings. Applying a given model to a particular area requires environmental data from sensors and the characteristics of the airflow field traversing the area of interest. The art is trending towards regional climate models that can use data points at increasingly fine resolutions, in some cases spaced apart 1 km or less. See Prein, A. F., et al., “A Review on Regional Convection-Permitting Climate Modeling: Demonstrations, Prospects, and Challenges,” Reviews of Geophysic, vol. 53.2 (2015), pages 323-361, and González, J. E., et al., “Urban Climate and Resiliency: A Synthesis Report of State of the Art and Future Research Directions,” Urban Climate, vol. 38 (2021), pages 1-19. Observational tools that can provide near real-time, high-resolution spatial and temporal data to support improved weather prediction and climate modeling are thus in high demand.

On a finer scale, urban settings comprising a multitude of structures of varying height and volumes create what is known in the prior art as an urban boundary layer (UBL). UBLs play a central role in urban meteorology, but present an especially challenging modeling environment because applying climate and weather models to the complex flow field of a UBL requires understanding and quantifying air flow processes such as the transportation of mass, momentum, heat, humidity, trace gases and pollutants. But as far as is known, established meteorological observational methods do not provide data with the necessary spatial and temporal characteristics. Accordingly, the ability of the prior art to understand, model and predict UBLs is limited. Attempts to address this issue by applying classic scaling laws to existing regional climate and weather models based on data points at larger distances have yielded limited results. Further limiting the utility of the prior art is the lack of a turbulence theory that fully takes into account the dynamic and heterogeneous thermal and momentum boundary conditions of urban boundary layers.

Disclosed here are methods and systems for generating more complete data to provide a more accurate picture of atmospheric conditions, and thus to improve the accuracy and utility of existing climate and weather models when applied to a particular region. Although the disclosed techniques are especially useful in urban settings, the described techniques are not so limited, as will be apparent from the description of preferred embodiments that follows.

### BRIEF DESCRIPTION OF THE DRAWINGS

The objects of the invention will be better understood from the detailed description of its preferred embodiments which follows below, when taken in conjunction with the accompanying drawings, in which like numerals and letters refer to like features throughout. The following is a brief identification of the drawing figures used in the accompanying detailed description.

FIG. 1 depicts a prior art model of the urban boundary layer formed by houses, trees, vehicles and urban structures of various heights and volumes in the presence of a prevailing wind.

FIG. 2 depicts a prior art model of the flow field in an urban area at a street scale of 10 m to 100 m in the presence of a prevailing wind.

FIG. 3 depicts an example of a system for implementing bubble thermography velocimetry (BTV) in accordance with the present disclosure.

FIG. 4 is a flowchart illustrating the steps of one preferred method of bubble thermography velocimetry.

FIG. 5 is plot of the thermal absorption coefficient abscoeff of soap bubbles (liquid water), CO₂, and water vapor vs. wavelengths across a spectrum of 1-20 μm, illustrating the relative greater thermal visibility of soap bubbles at wavelengths in an infrared window between 9 μm and 13 μm.

FIG. 6 is a plot of the ratio ρ̅ of the density of soap bubbles ρ_{b} to the density of the ambient air ρₐₐ vs. soap bubble diameter d_{b} for five different bubble temperatures T_{ba}.

FIG. 7 is a plot of a parameter v*_{b} defined as the bubble settling (or rising) velocity in m/sec vs. |ρ̅−1| for soap bubble diameters d_{b} of 80 mm and 150 mm.

FIG. 8 is a plot of a parameter τ_{b} defined as the bubble time constant in seconds vs. the ambient air velocity u₀ in m/sec for soap bubble diameters d_{b} of 80 mm and 150 mm.

FIG. 9 plots values of ρ̅ vs. soap bubble diameter d_{b} in mm for various gases used in the bubbles.

FIG. 10 is a combined plot of two parameters vs. long wavelength infrared (LWIR) camera focal length f₀ in mm. The left ordinate is the is maximum object distance d_{o,max} in km and the right ordinate is the corresponding field of view d_{x,max} in km for the same data point.

FIG. 11 illustrates the path of a soap bubble and the velocity vector associated with it at given time intervals calculated from position information provided by BTV.

FIG. 12 is a table contrasting BTV with various properties and characteristics of prior art techniques for defining fluid flows for use in climate and weather models.

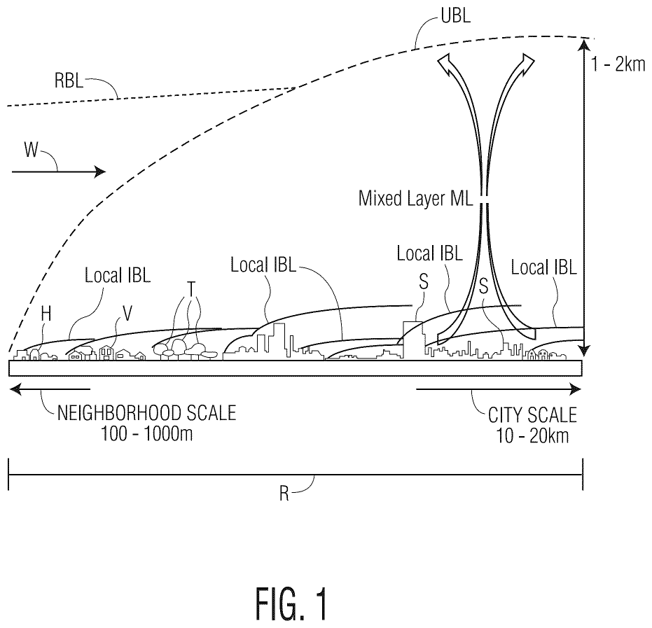

One skilled in the art will readily understand that FIGS. 1-3 and 11 are not strictly to scale, but nevertheless will find them sufficient, when taken with the other drawings and the detailed descriptions of preferred embodiments that follow, to fully describe, and to make and use, the claimed invention.

### DETAILED DESCRIPTION OF PREFERRED EMBODIMENTS

The detailed description that follows is intended to provide specific examples of particular embodiments illustrating various ways of implementing the claimed subject matter. It is written to take into account the level of knowledge of one of ordinary skill in the art to which the claimed subject matter pertains. Accordingly, certain details may be omitted as being unnecessary for enabling a person skilled in the art relating to the subjects disclosed here to realize the described embodiments. That person would have an advanced engineering or science degree, and would be familiar with climate and weather models involving advanced computer programs capable of applying mathematical algorithms for analyzing complex fluid flows.

In general, terms used throughout have the ordinary and customary meaning that would be ascribed to them by one of ordinary skill in the art. However, some of the terms used will be explicitly defined and that definition is meant to apply throughout. For example, the term “substantially” is sometimes used to indicate a degree of similarity of one property or parameter to another. This means that the properties or parameters are sufficiently similar in value to achieve the purpose ascribed to them in the context of the description accompanying the use of the term. Exact equivalence of many properties or parameters discussed herein is not possible because of factors such as engineering tolerances and normal variations in operating conditions, but such deviations from an exact identity still fall within the meaning herein of being “substantially” the same. Likewise, omission of the term “substantially” when equating two such properties or parameters does not imply that they are identical unless the context suggests otherwise or it is so stated.

Another term used in this disclosure is “about” and its equivalent “approximately.” Similar to the term “substantially,” those terms are used to indicate that there can be a certain amount of deviation from the value stated because of its inherent nature. The terms allow variances from a particular value if they serve the stated purpose or are intended to do so in the context in which they are used. Likewise, omission of the term “about” or “approximately” does not imply that the parameter referred to is limited to exactly the stated value, unless the context suggests or it is so stated.

### I. The Urban Boundary Layer

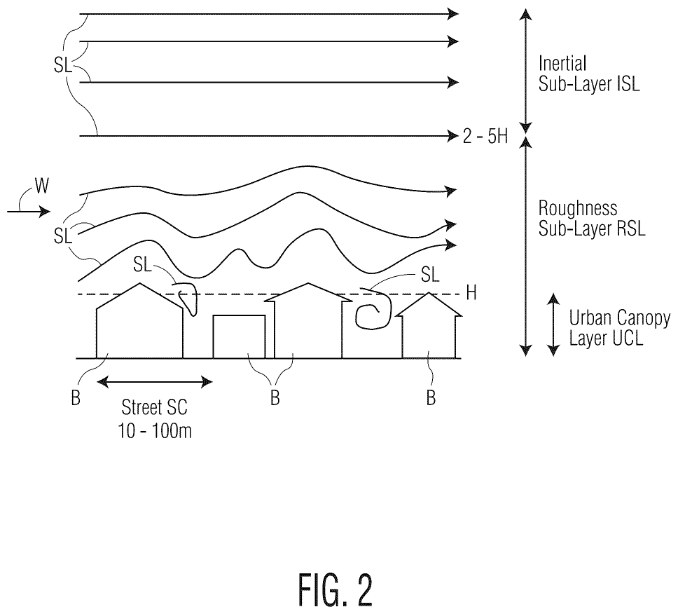

One current model of the complex UBL flow field is depicted in FIGS. 1 and 2, based on FIGS. 1 and 2 in Barlow, J. F., “Progress in Observing and Modelling the Urban Boundary Layer,” Urban Climate, vol. 10 (2014), pages 216-240, which is incorporated by reference as part of the present disclosure as if set out in full herein. FIG. 1 depicts in stylized fashion a cross-section of a region R encompassing one or more subregions of scales ranging from about 10 m to 100 m (neighborhood scale) up to 10 km to 20 km (city scale). A suburban region is shown comprising houses H, trees T and vehicles V (“obstructions”). A central city will include some or all of those kinds of obstructions, plus taller and bigger buildings S. Any given region R under consideration can be modeled with various subregions in various relationships to each other relative to the prevailing wind W. In the depicted model, individual obstructions form local internal boundary layers depicted by the solid lines IBL. The model posits the complex nature of UBLs where intense mixing occurs among local IBLs originating from various structures, urban thermal plumes and the incoming rural boundary layer RBL. The result is a progressively thickened urban boundary layer UBL depicted by the heavy dashed line bounding a notional mixed layer ML. In this model the UBL height is shown at a scale of 1 km to 2 km, which is enlarged relative to the scale of the region R for purposes of illustration.

FIG. 2 models a flow field in an urban area on a street level scale SC of 10 m to 100 m. This diagram illustrates the complexities of the flow field, represented by the streamlines SL, when considered at a scale that takes into account individual structures such as the notionally represented buildings B. The model considers the flow in three separate layers. An urban canopy layer UCL between the ground and the mean building height H considers the turbulence in the volumes between the buildings. A roughness sub-layer RSL reflects the somewhat more ordered flow between the height H and an altitude of 2H to 5H. An inertial sub-layer ISL above the RSL in which the flow becomes more ordered.

Climate and weather models apply algorithms that depend on the characteristics of the flow field in a particular region. They use air flow velocity and direction through a particular region of interest to determine how materials and parameters of interest are transported and distributed in the region under study. Conceptually, known techniques create a “picture” of a flow field by solving equations governing the air flow in the field. In general, more granular data points and the availability of reliable observational data yield better predictions when applied in a climate or weather model. The bubble thermography velocimetry systems and methods described below improve on certain important parameters that provide a way to quantify the manner in which it increases the utility of climate and weather models.

### II Three-Dimensional Bubble Thermography Velocimetry

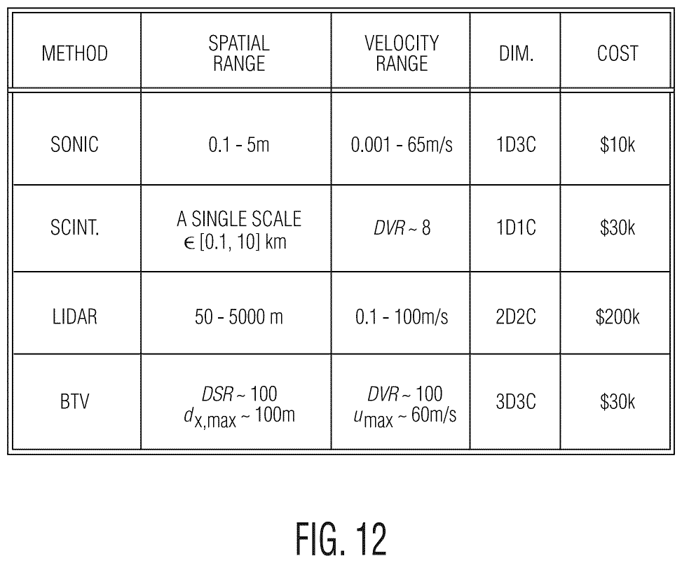

Bubble thermography velocimetry is a form of a known technique called particle image velocimetry (PIV) for creating a “picture” of a flow field by tracking the paths of entrained particles over time. The prior art describes numerous techniques for measuring flow fields, some main ones of which are described at pages 1-3 of the '537 provisional application. They include point-wise methods such as sonic anemometry; integral methods such as scintillometry; and flow field methods such as LIDAR (light detection and ranging), radar and SODAR (sonic detection and ranging). The performance capabilities of these techniques vis-à-vis BTV are summarized further below with reference to FIG. 12.

Another type of flow field mapping used to quantify atmospheric turbulence falls within the broad definition of particle image velocimetry (PIV), so-called because it tracks tracer particles introduced to the flow for that purpose. In order to achieve a large field of view (meters to tens of meters) in practical applications, large-scale PIV usually requires adaptations in the choice of tracer particle and illumination methods, in contrast to laboratory-scale PIV techniques that use micron-sized particles and high-power lasers. For example, applications in the field have used natural or artificial snowflakes as tracer particles in combination with high-power LEDs or xenon lamps for defining atmospheric boundary layers and wind turbine wakes. Centimeter-sized soap bubbles have also been utilized to measure atmospheric flow, and methods like filling soap bubbles with fog and creating glare points by artificial lighting have been used to enable visualization and tracking of the airborne soap bubbles. In addition, using helium-filled soap bubbles in visual tracking PIV processes has been proposed because they can be made neutrally buoyant.

Previous large-scale PIV methods, while generally effective for their intended purpose, nonetheless have limitations making them largely unsuitable for many applications, particularly in urban areas. The required high-power light sources are generally disturbing or even hazardous to urban populations, and natural and artificial snowflakes are largely unavailable or impractical to use as tracers in urban areas. In addition, the maximum measurable spatial scales achievable by most existing large-scale PIV techniques is limited to about 10 m, which limits their practicability for the larger scale analyses preferable in urban meteorology. Although snow PIV can measure fields of view of tens of meters, using snowflakes as tracer particles is impractical in urban environments.

### A. Exemplary Bubble Thermography Velocimetry System

In a basic form, bubble thermography velocimetry is a type of large-scale PIV, but not subject to the limitations of light-based PIV. BTV determines the flow characteristics of a three-dimensional fluid flow by introducing into the fluid flow a plurality of bubbles buoyant in the fluid and having a predetermined size and temperature, detecting the positions of individual bubbles entrained in the flow at predetermined time intervals using an infrared detecting device, and using the positions of the individual bubbles to determine the velocity and direction of a plurality of the bubbles at predetermined locations in the flow field. In one preferred embodiment, the infrared detecting device is a long wavelength infrared camera (LWIR), and the size and temperature of the bubbles introduced into said fluid flow are selected so that they last for a predetermined distance while entrained in said flow and the LWIR focal length and aperture size settings keep the bubbles in focus over the predetermined distance. In a further preferred embodiment, the bubbles are soap bubbles.

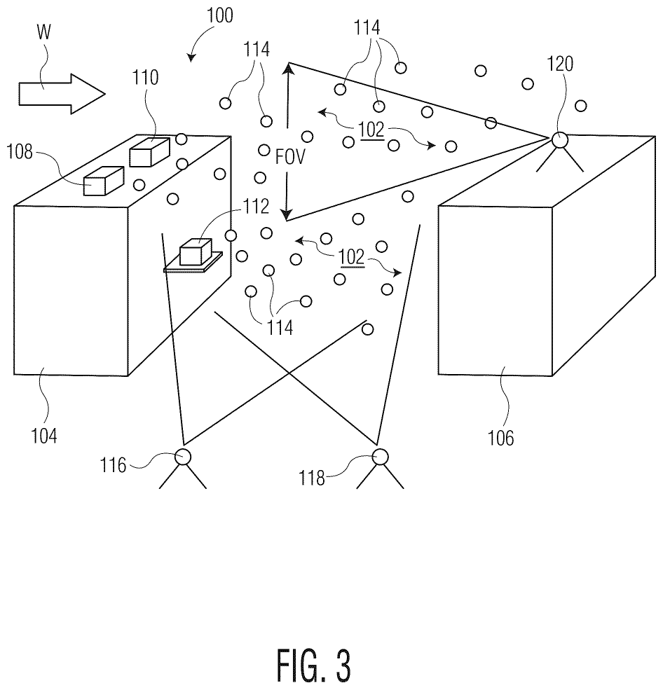

FIG. 3 is a schematic diagram of an exemplary system 100 for performing bubble thermography velocimetry in accordance with the present disclosure. The target area 102 to be mapped by BTV is the area between and surrounding two buildings 104 and 106 in the presence of a wind W. This example represents a system operating at the street scale of 10 to 100 m (the range of dimensions of the buildings and the space between them) shown in FIG. 2. Bubble generators 108, 110 and 112 produce soap bubbles 114 that are entrained in the flow field produced by the wind throughout the target area. For clarity of illustration, FIG. 3 depicts only a small percentage of the bubbles actually produced. Depending on the application, bubbles will typically be produced in quantities and at rates designed to produce a bubble density in the target area up to about 200 bubbles per 32×32 pixel field of the sensing device (described in the next paragraph). The system can monitor the bubble density in real time by sampling the sensor output and adjusting the rate of bubble production accordingly. If the bubble density is too high, it will prevent tracking of some of the bubbles that are farther away, while a density that is too low may not produce meaningful number of data points. The bubble generators are located so that they produce a more or less uniform density throughout the target area 102. Bubble distribution can be determined by comparing the output of different sensors over time.

A plurality of thermal sensors comprising LWIR digital cameras 116, 118 and 120 record the positions of the entrained bubbles as they travel through the target area 102. As discussed in section II.B.2, each of the cameras is capable of accurately mapping a field of view FOV up to 100 meters in diameter. (FIG. 3 depicts FOV in two dimensions for clarity of illustration.) As also discussed later, the cameras are capable of mapping at a selected depth of field while maintaining an FOV diameter up to 100 m. In almost all cases, the depth of field of the cameras are set to infinity (that is, from some finite distance in front of a camera to infinity). The actual imaged depth would be dictated by the spread of bubbles in that depth direction, the thermal visibility (decreasing with distance) and obstruction by other structures like buildings. In other embodiments, different thermal sensors can be used alone or in combination with LWIR cameras for mapping the tracks of the soap bubbles. In another variation, medium wavelength infrared (MWIR) cameras can be used alone or in combination with other types of sensors.

### B. Principal Components of Preferred BTV Methods

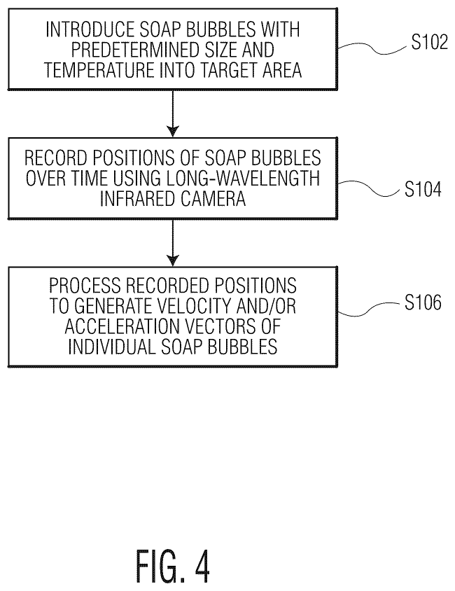

As described in the '537 provisional application, the BTV methods described herein utilize two components: soap bubbles and one or more long wavelength infrared cameras. In a basic form illustrated in FIG. 4, it comprises a first step S102 of introducing bubbles 114 of a predetermined size and temperature into a target area 102 as shown in FIG. 3. In a preferred embodiment the bubbles are soap bubbles generated according to the description in the next section. The following step S104 records the positions of the bubbles over time using one or more infrared detecting devices such as the LWIR cameras 116-118 shown in FIG. 3. The properties and operation of the LWIRs are described in more detail in the next section II.B.2. The next step S106 processes the position/time information recorded by the LWIR cameras to enable it to be used in existing models that analyze various properties of the environment within the target area.

### 1. Soap Bubbles

Soap bubbles are proposed as the tracer in urban atmospheric flow because they are low cost, straightforward to generate, and float in air. There are also other considerations such as thermal visibility, velocity fidelity and bubble lifetime that may not be obvious but are also important in optimizing the performance of BTV.

a. Bubble Thermal Visibility

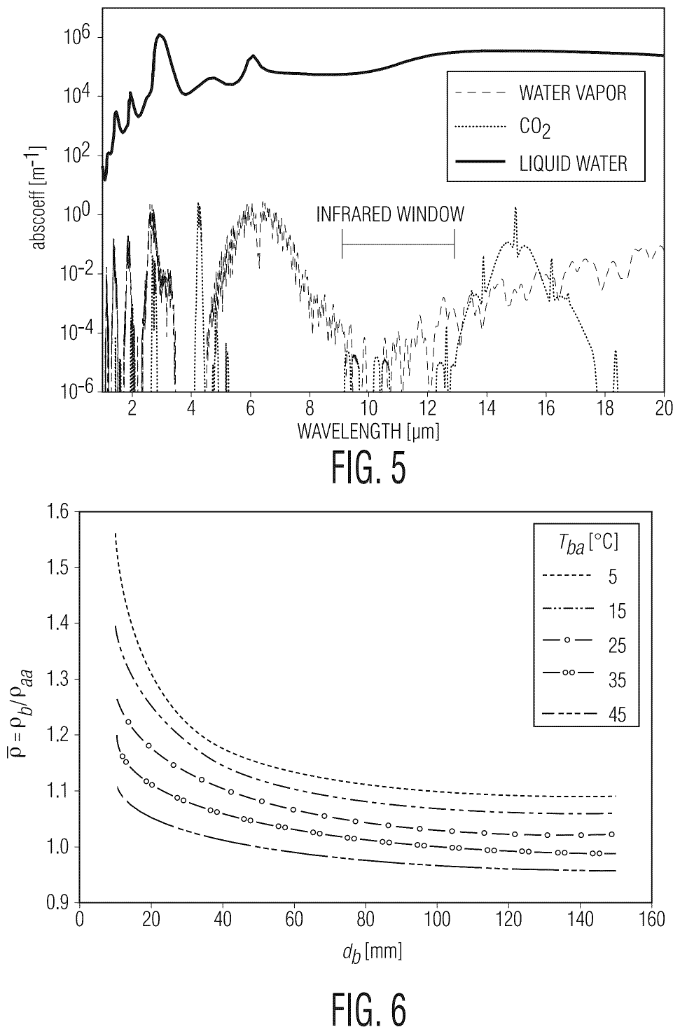

The thermal visibility of airborne soap bubbles (quantified by a parameter I) is dictated by the thermal radiation of liquid water (bubble solution), atmospheric attenuation and properties of the imaging system, per equation (1) in the '537 provisional application. FIG. 5 shows that an “infrared window” of wavelengths exists between about 9 μm and 13 μm, where the absorption coefficients abscoeff of CO₂ and water vapor, the two major IR absorbing gases in the atmosphere, are exponentially lower than the value of abscoeff of liquid water (bubble solution), which is a strong IR emitter. This is an important aspect of the method because it allows the use of thermal imaging instead of requiring the target area to be illuminated with high-power LEDs or xenon lamps as with prior forms of PIV, making them impractical for use in populated areas as already pointed out.

b. Bubble Dynamics

The velocity fidelity of soap bubbles can be evaluated using the bubble dynamics equation (2) in the '537 provisional application, which relates the bubble acceleration dv_{b}/dt to the forces exerted on the bubble and dependent on the wind velocity field u, and |u−v_{b}| indicates the extent to which the soap bubble velocity v_{b} deviates from the wind velocity u. Equation (2) demonstrates that ρ̅ and d_{b} are two key parameters governing bubble dynamics, where ρ̅=ρ_{b}/ρₐₐ, d_{b} is the bubble diameter, ρ_{b} is the density of the bubble, and ρₐₐ is the density of the ambient air. The factors governing ρ̅ are the bubble film thickness, the bubble air density and d_{b}. The bubble diameter d_{b}, considering thermal signal strength and the scales of UBL interest, is preferably chosen to be at least about 100 mm. This yields a ρ̅ value close to 1.0, as shown in FIG. 6, which plots ρ̅ against d_{b} values between 10 mm and 150 mm over a range of bubble diameters and bubble internal air temperatures T_{ba}, where ρ̅=1 is substantially neutrally buoyant. A preferred value of |ρ̅−1| will be less than 5%; a useful range of d_{b} is greater than 80 mm; and the ambient air temperature Tₐₐ (25° C. in FIG. 6) will be greater than T_{ba} by up to about 20° C. In other applications, it may be preferable to use |ρ̅−1| up to 10%.

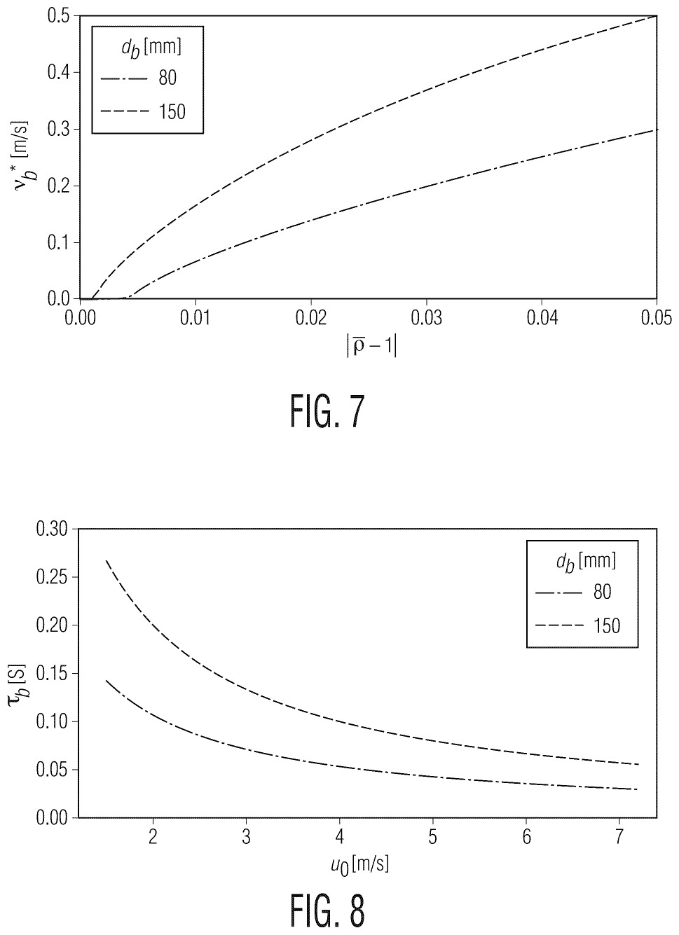

Another important factor is the settling (rising) velocity of a bubble v*_{b}. This parameter relates to the time a bubble stays within the field of view, which affects the maximum measurement duration and bubble travel distance. It also characterizes the fidelity of a BTV system in measuring vertical flow motion. FIG. 7 shows the dependence of v*_{b} on the density ratio |ρ̅−1| within the preferred range of less than 5% for bubble diameters d_{b}=80 and 150 mm as discussed in the previous paragraph. The maximum settling (rising) velocity is about 0.25 m/s for d_{b}=150 mm, which is about 10% or less of the velocity in the lower 50-100 m of the UBL, and about two to three times the root mean square of the velocity in the UBL.

The bubble time constant Tb depicted in FIG. 8 is another important parameter. It is plotted as a function of the surrounding flow velocity u₀ between 1.0 and 7.2 m/s for bubble diameters of 80 and 150 mm. τ_{b} characterizes the ability of a bubble to respond to (catch up with) a step change of value u₀. Realistic atmospheric flows constantly change speed and direction, and therefore τ_{b} characterizes the velocity fidelity of measurement conducted by BTV. Specifically, the values of τ_{b} shown in FIG. 8 define the time duration needed for a bubble starting from still to accelerate to 50% of the surrounding flow velocity. For example, at u₀=4 m/s and d_{b}=80 mm, an initially still bubble takes about 0.06 second to accelerate to 2 m/s.

### Bubble Solution and Bubble Lifetime

The lifetime of soap bubbles determines the distance they travel, which in turn affects the positioning of the bubble generator and the maximum length scale that a BTV system can measure. Three important ingredients are a surfactant such as dish soap, one or more long-chain polymers such as guar gum, and a humectant such as glycerol, all of which are readily available, nontoxic and eco-friendly (using biodegradable dish soap).

In addition to the composition of bubble solution, bubble lifetime also depends on humidity, bubble diameter, wind conditions, etc. There are no known systematic studies on soap bubble lifetimes under realistic atmospheric conditions. However, some insights may be gained from laboratory studies in well controlled environment. Reference no. 40 of the '537 provisional application reports a lifetime of 60-80 seconds for a 100×150 mm² two-dimensional soap film with an optimal concentration of guar and a relative humidity (RH) between 0.4 and 0.8. Lifetime increased to 200-300 sec at RH≥0.9, while RH values below 0.3 were generally challenging. However, reference no. 34 reports making a soap film 12 mm in diameter and lasting over 400 sec at RH=0.2 by adding 20% glycerol. To place the numbers in a context, Phoenix, one of the driest cities in the U.S., has an annual average RH of 0.4 with the lowest monthly average being 0.2 in May and June.

Ata wind speed of 4 m/s, for example, a bubble lifetime of 80 sec means that bubbles travel 320 m, which limits the maximum length scale (the field of view) resolvable by BTV. The maximum travel distance probably has a lessening growth rate with increasing wind speed, as bubbles have a stronger tendency to break due to increased turbulent stress and/or increased Weber number (the ratio of inertia force to surface tension) during acceleration by the surrounding flow. This can be further quantified by field experiment, but for present purposes a travel distance of a few hundred meters is deemed reasonable, the discussion further below shows that the actual maximum resolvable length scale is within the maximum travel distance of bubbles. When a much larger field of view is desirable, multiple BTV systems can be used in tandem.

d. Bubble Generation

The bubble seeding density is dictated by the number of bubbles in the image space, for which 10 bubbles per 32×32 pixel window has been deemed sufficient by prior PIV studies, reported in reference no. 13 of the '537 provisional application. With a 1280×1024 pixel sensor, the total number of bubbles is 12,800 per snapshot. At the specified wind speed and a 100 m field of view, for example, the bubble production rate is 12,800/25=512 bubbles/s. Correspondingly, with d_{b}=50 mm and a 1.0 μm film thickness, the required air flow rate is about 1.2 m³/sec (2400 cfm), accounting for both the air inside bubbles and the flow pushing the bubbles out from the bubble generator outlet. The bubble liquid consumption is 36 ml/s. If a one-minute measurement is taken every hour, the monthly consumption of bubble liquid will be about 400 gallons.

Another desirable feature for bubble generation is controlling bubble temperature, considering that the velocity thermal visibly equation (1) in the '537 provisional application includes a thermal radiation term and the effects of bubble density already discussed. Using as an example a finned tubular heater having a typical efficiency exceeding 90%, the power required to heat air flow at 1.2 m³/sec is 1600 W/K. It is expected that a single commercial finned tubular heater will be capable of raising the temperature used to create the bubbles, although the amount of the increase might be somewhat unpredictable and the bubble temperature (and density) will decrease over time.

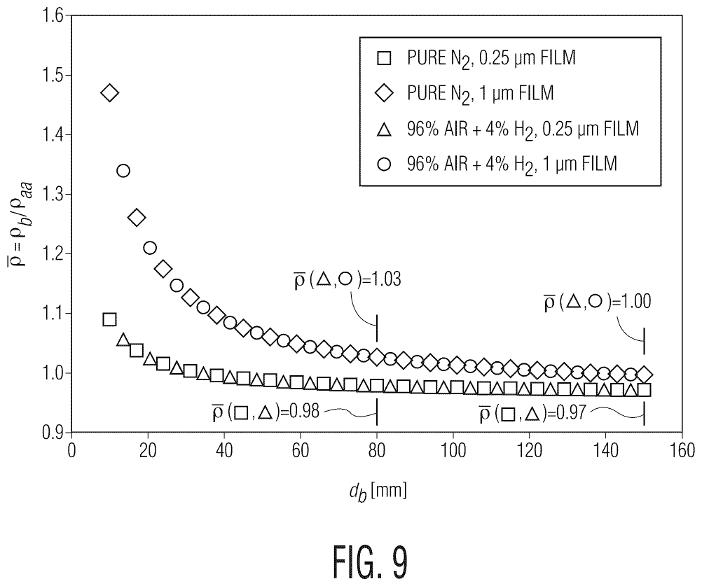

A more precise way to control bubble density, albeit more expensive, is to use different combinations of hydrogen, nitrogen and air. FIG. 9 plots the bubble density ratio defined previously for two filling gas compositions (assuming the same temperature inside and outside the bubble). For two different bubble film thicknesses (0.25 μm and 1.0 μm) and for bubbles filled with pure nitrogen, the value of |ρ̅−1| varied only 0.01 for bubble diameters between 80 mm and 150 mm, or about 1%. For the same two bubble thicknesses, with bubbles filled with 96% air and 4% hydrogen, the variation was 0.03 mm (3%). Both values are within the preferred range of |ρ̅−1| less than 5% discussed in the Bubble Dynamics section. Other gasses or combinations thereof and other film thicknesses can be used, the desired result being that the density of the bubbles result in a rising/settling rate (see FIG. 7) that makes them buoyant over a distance greater than a linear dimension of a field of view of the LWIR camera used to track them, as discussed in section II.B.2. A preferred range of film thicknesses is 0.01 μm to 1.0 μm.

FIG. 7 in the '537 provisional application illustrates a prototype bubble generating apparatus that used only air as the filling gas. It comprised two duct fans of 0.6 m³/s (1200 CFM) each, a finned tubular heater of 7,000 W, and a 200-gallon tank. The bubble generating mechanism is of a generic type, adopted in many commercial-grade bubble machines, such as the B-550 Bubble King, made by Chauvet DJ, 3360 Davie Road, Suite 509, Davie, FL 33314. The prototype machine employed plural spinning wheels in tandem with wands attached on the rims carrying soap films from a reservoir to the outlet. With six sets of 12 wands (see FIG. 7 of the '537 provisional application), the prototype machine produced 512 bubbles/sec running at about 400 rpm. For that particular speed, and based on an estimate of the drag on wands moving through the reservoir, it was determined that a 3 HP, 1800 rpm or 3600 rpm AC motor was sufficient to drive the wand wheels.

Other bubble generating apparatuses can be used depending on the analysis being performed. For example, when the wind speed increases or a smaller field of view is desirable, multiple heaters can be stacked and duct fans with higher flow rate can be used. In addition, under some circumstances the spread of a cloud of soap bubbles from a single generator might be insufficient, and two or more bubble generators of smaller sizes can be used to cover the entire measurement volume.

The above discussion describes several preferred ways to create bubbles that have a rising/settling rate making them sufficiently buoyant as they are carried through a target area. They include using different film thicknesses, filling the bubbles with a mixture of gases appropriate to the task, and adjusting bubble temperature via using particular temperatures of the liquid used to form the bubble film or of the temperature of its gaseous filling, or both. In a given application bubble temperatures may be up to 50° C. higher or lower than that of the surrounding air.

### 2. Long-Wavelength Infrared (LWIR) Camera

a. Specifications

LWIR cameras have a typical spectral range of 8-14 μm, which substantially matches the atmospheric IR window discussed in connection with FIG. 5. Because they detect IR radiation emitting from objects, LWIR cameras do not require light to detect bubble positions. There are two basic types of LWIR cameras—cooled and uncooled. The various characteristics of both are discussed on page 8 of the '537 provisional application. Two particular models suitable for BTV are uncooled Model FT II Long Wave Infrared Camera Module made by iRayUSA, 2601 State Hwy. 121, Bldg. 3, Suite 306, Lewisville, TX 75056, and cooled Model X8580 Infrared Camera made by FLIR Systems, Inc., 27700 SW Parkway Ave., Wilsonville, OR 97070. The uncooled FT II camera is designed with f_{#}=1 and attains a thermal sensitivity of 50 mK, while the same parameters for FLIR's cooled camera are sufficiently similar, with a thermal sensitivity of 40 mK at f_{#}=2.5, so that uncooled LWIR cameras should be adequate for BTV systems described in this disclosure. An alternate uncooled LWIR is the Teledyne FLIR BOSON 640×512 18 mm 24° HFOV—LWIR, also made by FLIR Systems, Inc.

b. Calibration

The accuracy of BTV depends on proper calibration of the LWIR cameras. Because BTV operates on large scales (tens to hundreds of meters), the conventional method of moving a calibration target in the measurement volume described in references nos. 41-43 of the '537 provisional application is impractical. However, a two-step calibration method using separately performed intrinsic and extrinsic calibrations will provide the required accuracy. Intrinsic calibration performed prior to deploying the cameras in the field establishes a mapping relation between pixel coordinates and lines-of-sight in a camera coordinate system relative to the camera itself. Then, an extrinsic calibration is performed during field setup to determine the position and orientation of each camera to establish the relation between the cameras' coordinate systems and a geographic coordinate system (GCS) defining the target area (see FIG. 3). This enables the processing system (see FIG. 4) to determine bubble locations by triangulation so that the resulting bubble velocity vectors v_{b} (see FIG. 11) will be expressed in relation to the geographic coordinate system.

Using self-calibration mitigates uncertainties in camera positioning due to factors such as initial setup error or movement by wind loading during operation by the aligning the calibration function of each camera using bubbles in the measurement volume. A suitable self-calibration technique is disclosed in Wieneke, B., “Volume Self-Calibration for 3D Particle Image Velocimetry,” Experiments in Fluids, vol. 45.4 (2008), pages 549-556, the entire contents of which are incorporated by reference as part of the present disclosure as if set out in full herein. Self-calibration reduces the effect of inaccuracies that can arise because the lines-of-sight belonging to the same bubble may not intersect in the object space, which can introduce errors in triangulation and velocity measurement.

In a preferred form, intrinsic calibration starts from knowing the focal length f and pixel size of the LWIR camera and is refined by imaging a target comprising a known dot array traversed along an optical rail. Extrinsic calibration is performed in the field by measuring camera 3-D orientations and their relative and absolute positions. Orientations are measured with respect to the GCS using 3-axis accelerometers and compasses. Relative distances and angles between the cameras are measured with a laser distance meter features a point-finder camera and point-to-point (p2p) distance and angle measurement, such as a Mileseey S7 330 ft. Outdoor Laser Measure with Camera, available from Mileseey Tools, 17800 Castleton St. Ste. 665 City of Industry, CA 91748. Camera positions in the GCS are obtained by either referencing a local landmark or via GPS.

c. Thermal Visibility Range and Field of View

Estimating the maximum length scale resolvable by BTV requires knowing the maximum distance at which soap bubbles are visible on the thermal images acquired by the LWIR camera. For example, if the camera lens has a field of view (FOV) of 75° and the maximum visible distance is d_{o,max}=70 m, then the maximum resolvable length scale is d_{x,max}=tan (75°/2)×d_{o,max}×2≈100 m. However, the maximum resolvable length can be set at any value appropriate to the application, which can be up to 200 m. Scaling equation (1) in the '537 provisional application is used to derive d_{o,max} as a function of the focal length f₀. A reference value for thermal visibility can be determined by using the simulation result described in Perić et al., “Thermal Imager Range: Predictions, Expectations, and Reality,” Sensors, vol. 19.15 (2019), pages 1-23, the entire contents of which is incorporated by reference as part of the present disclosure as if set out in full herein. Perić determined a value of d_{o,max}=4.3 km for an object of the size of a human with parameters (μ, f_{#}, f₀)=(0.2 km⁻¹, 225 mm, 1.5), wherein μ is an absorption coefficient that characterizes the exponential attenuation of an object's thermal visibility per unit distance (see equation (1) in the '537 provisional application), and a value of d_{o,max}=3.7 km for an object with a value of ρ=3.5 km⁻¹.

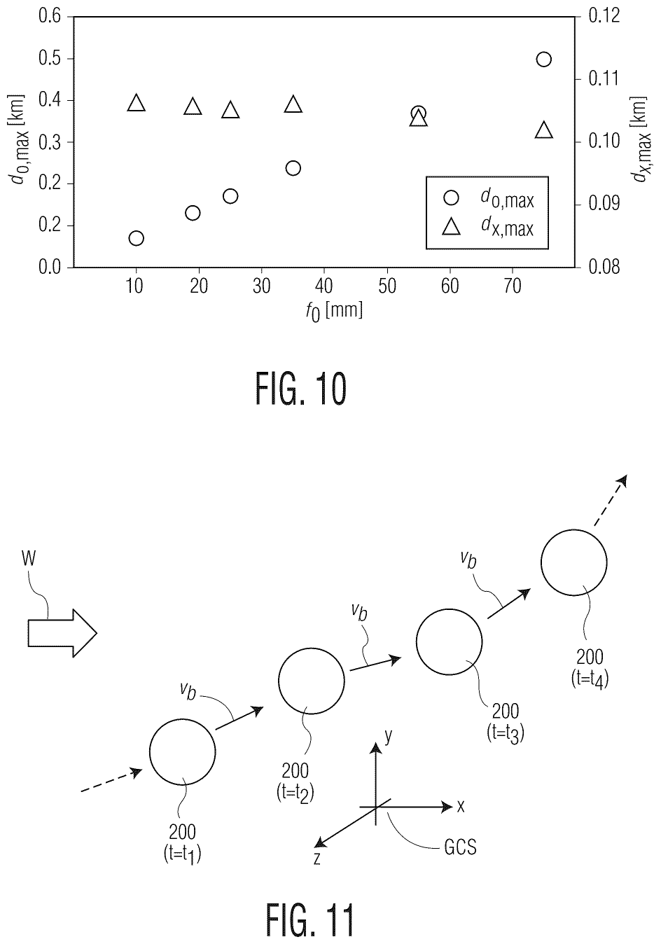

The '537 provisional application explains at pages 8 and 9 how Peric's results with a human-size object were scaled to a BTV method according to the present disclosure, by assuming (i) that a 150 mm diameter soap bubble (d_{b}=150 mm) is about 1/40 of the size of a human; (ii) using the iRayUSA Model FT II Long Wave Infrared Camera Module specifications of f₀∈[10,75] and f_{#}=1.0; and (iii) assuming that a soap bubble has the same thermal sensitivity parameter n as the imaging system used by Perić (see equation (1) in the '537 provisional application). FIG. 10 presents the results, whereby the maximum object distance d_{o,max}, and the corresponding field of view d_{x,max} are plotted against camera focal length f₀ for 150 mm soap bubbles (d_{b}=150 mm). Notable in this graph is that surprisingly d_{o,max}, represented by the round data points and plotted on the left y-axis increases approximately linearly with f₀, but d_{x,max}, represented by the square data points and plotted on the right y-axis is substantially equal to 100 mm regardless of focal length. In other words, the maximum object distance d_{o,max} can be set by choosing the appropriate value of f₀, while the maximum resolvable length (i.e., the size of the field in focus) represented by the parameter d_{x,max} will be substantially constant at 100 m. Accordingly, the exemplary BTV methods described in the proceeding sections will be capable of accurately mapping any particular area of 100 m on a side (the field of view of the BTV embodiment described above) at a desired object distance using soap bubbles about 150 mm in diameter. In addition, d_{x,max} depends only weakly on the bubble thermal absorption coefficient μ, and only decreases from about 108 m to about 88 m at f₀=75 mm when μ increases from 0.01 to 1.0 km⁻¹. See equation (2) in the '537 provisional application.

### C. Post-Mapping Processing BTV Results

Although BTV differs from general PIV by, among other things, the tracer particles (soap bubbles) and the way they are imaged (thermal imaging), techniques of image interrogation, 3-D reconstruction and post-processing are generally the same for BTV and PIV. Although there are many reconstruction algorithms suitable to the purpose, two examples are described in
Ding, L., “Fundamentals and Applications of N-pulse Particle Image Velocimetry-accelerometry: Towards Advanced Measurements of Complex Flows and Turbulence,” A Dissertation Presented in Partial Fulfillment of the Requirements for the Degree Doctor of Philosophy, Arizona State University (2018), pages 173-183, attached as Appendix A.
Schanz, D., et al., “Shake-The-Box: Lagrangian Particle Tracking at High Particle Image Densities,” Experiments in Fluids, vol. 57, no. 20 (2016), pages 1-27, attached as Appendix B.

Ding employs a surface segmentation method (SS) that is a fast, parallelizable algorithm for computing the volumetric intensity distribution. Schanz's so-called shake-the-box (STB) algorithm is more suitable when the highest possible data quality is more important than turnaround time. Examples include development of parameterization schemes for weather and climate models, urban dispersion studies, building wind load analysis, etc. For such applications, STB will be used to maximize dynamic spatial range (DSR) and dynamic velocity range (DVR). In comparison to SS, STB yields a higher density of velocity vectors, albeit at the cost of increased computational burden. Both algorithms are able to track particle motion in time.

The parameter DSR is the ratio of the largest to the smallest spatial scale of motion resolvable by a particular system, “spatial scale of motion” being the spatial extent of a region in a target area where the air will move in an organized way (for example, swirling motion in a vortex or a region with uniform velocity). It accounts for the existence in the generally disorganized turbulent flow in the target area (see FIG. 2) of many different types of organized motion spanning a wide range of spatial scales. DVR is the ratio of the largest to the smallest velocity resolvable by the system. DSR and DVR emphasize the ratio but not the absolute largest (or smallest) scale. These are particularly important parameters because atmospheric turbulence, especially in urban boundary layers, comprises an extremely wide range of spatial and velocity scales. A preferred method of measuring atmospheric flows will be able to simultaneously resolve turbulent motions over wide spatial and velocity ranges, as quantified by the parameters DSR and DVR.

In that respect, BTV can measure flow over a field of view up to 100 m wide, with each velocity vector representing the averaged flow velocity over a 1-meter wide cell (or in which the averaged spacing between neighboring vectors is 1 m). Thus, the largest and smallest spatial scales resolvable by that application of BTV are 100 m and 1 m, yielding a DSR=100 (100/1). The term “dynamic” indicates that the spatial scale range can be customized to specific applications (e.g., from 0.5 m to 50 m) by adapting the imaging system parameters while maintaining DSR at 100. Likewise, a DVR of 100 represents the ability of BTV to measure flow speeds of up to 60 m/s, while the uncertainty level (or the minimum distinguishable velocity change) is 0.6 m/s, yielding a DVR=100 (60/0.6). DSR and DVR values of at least 50 can be obtained using the disclosed BTV methods and systems.

FIG. 11 illustrates in schematic form the results of post-mapping processing by depicting the track of a single bubble 200 in relation to the right-hand geographic coordinate system (GCS) defining the target area, in which the x-axis is generally in the direction of the prevailing wind. The processing algorithm calculates the velocity vector v_{b}[v_{bx}, v_{by}, v_{bz}] at predetermined time intervals t= . . . , t₁, t₂, t₃, t₄, . . . relative to the GCS.

That information permits the algorithm to calculate each bubble's velocity and acceleration as a function of time for use by the climate, weather or other environmental model. In an exemplary system, the time intervals tₙ₊₁−tₙ will be between 0.01 and 0.03 seconds, with the actual interval being determined by the flow speed and imaging system configuration in a particular application. A BTV system like that depicted in FIG. 3 will include a computer processing device (not shown) programmed to execute an algorithm such as one of those disclosed in Ding and Schanz for outputting data that defines the path of each bubble from the position/time information depicted in FIG. 11 in a form usable by the chosen environmental model.

D. Contrasting BTV with Prior Art Methods

FIG. 12 tabulates the manner in which BTV improves over the prior art methods of sonic anemometry, integral scintillometry, and flow field LIDAR discussed at the outset.

Regarding spatial range, BTV clearly fills the void in DSR between sonic anemometry and lidar/scintillometry. The range of length scales resolvable by BTV (1−100 m) is most relevant to the microscale meteorology on a street scale SC of a few blocks and within the roughness sub-layer RSL, typically 2-5 times of the mean building height (see FIG. 2). In addition, FIG. 10 shows that bubbles can be tracked over an object distance of up to few hundred meters (d_{o,max}), regardless of the field of view (d_{x,max}) which stays substantially the same. This gives BTV the potential to map fields much higher altitudes to characterize wakes of skyscrapers, wind turbines, etc. In contrast, sonic anemometry has a spatial range of 0.1-5 m and scintillometry can measure surface wind velocities at a particular distance ∈[0.1,10] km. Although particles up to 5000 m away can be tracked by LIDAR, particles closer than 50 m cannot

FIG. 12 illustrates the superiority of BTV in terms of DVR. For example, LIDAR can measure air flow up to 100 m/s with a typical uncertainty of 0.1 m/s, yielding a DVR=1000. However, it is not dynamic like BTV. Scintillometers for cross-wind measurements typically have an accuracy of 12% of the full scale, yielding DVR of about 8. Sonic methods measure air flow velocity and direction at a single point, rather than a “velocity range,” and thus do not have a DVR as such.

Another important consideration is the number of dimensions of the flow that can be determined by each method. BTV is a true 3D3C method, meaning that it can define the path and velocity vectors of the numerous bubbles in view in all three dimensions. This provides more dense information for the algorithm used to model the climate, weather, etc. None of the prior art methods have this capability. The maximum velocity measurable by BTV (˜60 m/s) is comparable to sonic anemometry and lidar and is more than sufficient for measuring wind speed in the lower atmosphere. Moreover, the $30K estimated cost of a BTV system (including LWIR cameras, a bubble generator, computing hardware and software packages) makes its performance-cost ratio attractive.

### IV. Summary And Conclusions

Anticipated applications of BTV in urban areas are focused on urban micrometeorology for which BTV is expected to deliver high-spatial-resolution flow data to inform underlying physics and support the development of regional weather models and large-eddy-simulation models, such as that described in Omidvar, H., et al., “Plume or Bubble? Mixed-Convection Flow Regimes and City-Scale Circulations,” J. Fluid Mech., vol. 897 (2020), pages 1-27. One example application is the study of pollutant transport in street canyons, where, in addition to characterizing local flow dynamics, bubbles can mimic how pollutants (or other passive tracers like pathogens) move and distribute. Another example application would measure the turbulent processes near rooftops to (i) test the existence and extent of the constant flux layer (CFL) defining the characteristics of a particular UBL, and (ii) examine the footprint for sonic anemometry and eddy covariance. Another application would use BTV to map the wake of large-scale wind turbines.

For BTV deployed in urban areas, practical considerations can be met by using power and water supplies of existing building facilities. Unattended preparation and refill of bubble liquid can be performed automatically by dispensing and mixing surfactants and other ingredients into system water tanks; given the low volume fraction (a few percent) of ingredients other than water, an on-site refill should last a few months. Communication for remote/automatic operations of the LWIR cameras can be done by the Internet Protocol (IP) via either Ethernet or WiFi available in the buildings or 5G cellular networks. Cameras can be protected by waterproof enclosures like those on surveillance/security thermal cameras. There are no privacy concerns with thermal imaging as glass windows are opaque to LWIR. And since BTV uses thermal cameras, it can operate in both daytime and nighttime. Anticipated applications of BTV in urban areas are focused on urban micrometeorology for which BTV can to deliver high-spatial-resolution flow data to inform underlying physics and support the development of large-eddy-simulation models and regional weather models.

Those skilled in the art will readily recognize that only selected preferred embodiments of the methods and constructions and their concomitant advantages have been depicted and described, and it will be understood that various changes and modifications can be made other than those specifically mentioned above without departing from the spirit and scope of inventions described here and defined solely by the claims that follow.

What is claimed is:

1. A method of determining flow characteristics of a three-dimensional fluid flow comprising:
introducing into the fluid flow a plurality of bubbles buoyant in said fluid and having a predetermined size and temperature; and
detecting the positions of individual said bubbles entrained in said flow at predetermined time intervals using one or more infrared detecting devices.

2. The method of claim 1, wherein:
said fluid comprises atmospheric air;
said bubbles are soap bubbles comprising a film of water and a surfactant enclosing a volume filled with a gaseous mixture; and
each of said one or more infrared detecting devices comprises a long wavelength infrared (LWIR) digital camera.

3. The method of claim 1, wherein said fluid comprises atmospheric air and each of said one or more said infrared detecting devices is a long wavelength infrared (LWIR) digital camera, said method further comprising:
selecting the size and temperature of said bubbles introduced into said fluid flow so that they last for a predetermined time while entrained in said flow;
setting an LWIR focal length and aperture size that maintains the bubbles in focus and in view over a predetermined linear distance within the flow field; and
using said positions of each of said individual bubbles to determine the velocity and direction of a plurality of said bubbles at predetermined locations in the flow field.

4. The method of claim 3, wherein said bubbles are soap bubbles comprising a film of water and a surfactant enclosing a volume filled with a gaseous mixture causing the bubbles to have a rising/settling rate in said atmospheric air that makes them buoyant over said linear distance during said detecting step.

5. The method of claim 4, wherein said gaseous mixture comprises one of (i) atmospheric air, (ii) 96% atmospheric air and 4% hydrogen, and (iii) nitrogen.

6. The method of claim 4, wherein said introducing step comprises generating bubbles the temperature of which is up to 50° C. higher or lower than the atmospheric air by adjusting the temperature of one of said film, said gaseous mixture, or both.

7. The method of claim 4, wherein said film is between 0.01 μm and 1.0 μm thick.

8. The method of claim 3, wherein said surfactant is soap and film further comprises at least one long-chain polymer and a humectant.

9. The method of claim 3, wherein a parameter p represents the ratio of the density ρ_{b} of said bubbles to the density ρₐₐ of the ambient air in said fluid flow (ρ̅=ρ_{b}/ρₐₐ) and |ρ̅−1|≤10%.

10. The method of claim 3 wherein said predetermined distance is between 10 m and 200 m.

11. The method of claim 3, wherein said LWIR camera has an imaging sensor comprising a two-dimensional field of temperature sensing pixels having a resolution of at least 640×512, and said bubbles are introduced to the flow field at a rate designed to produce a bubble density up to 200 bubbles per 32×32 pixels of said temperature-sensing pixel field.

12. A system for determining flow characteristics of a three-dimensional flow comprising atmospheric air, said system comprising:
at least one bubble generating device for introducing into the fluid flow a plurality of soap bubbles buoyant in said fluid and having a predetermined size and temperature;
one or more infrared detecting devices for detecting the positions of individual said bubbles entrained in said flow at predetermined time intervals;
a computer processor for executing an algorithm that determines the velocity and direction of each of a plurality of said bubbles at predetermined locations in the flow field from a record over a predetermined test period of said positions of said individual bubbles.

13. The system of claim 12, wherein said algorithm executes one of a surface segmentation method for determining a volumetric intensity distribution within the flow field and a shake-the-box Lagrangian particle tracking method.

14. The system of claim 12, wherein a parameter DVR (dynamic velocity range) defined as the ratio of largest to the smallest bubble velocity resolvable by said computer processor executing said algorithm is at least 50.

15. The system of claim 12, wherein a parameter DSR (dynamic spatial range) defined as the ratio of the largest to the smallest scale of motion resolvable by said computer processor executing said algorithm is at least 50.

16. The system of claim 15, wherein a parameter DVR (dynamic velocity range) defined as the ratio of largest to the smallest bubble velocity resolvable by said computer processor executing said algorithm is at least 50.

17. The system of claim 12, wherein a parameter DVR (dynamic velocity range) defined as the ratio of largest to the smallest bubble velocity resolvable by said at least one infrared detecting device is at least 50.

18. The system of claim 12, wherein a parameter DSR (dynamic spatial range) defined as the ratio of the largest to the smallest scale of motion resolvable by said at least one infrared detecting device is at least 50.

19. The system of claim 18, wherein a parameter DVR (dynamic velocity range) defined as the ratio of largest to the smallest bubble velocity resolvable by said at least one infrared detecting device is at least 50.

20. The system of claim 12, wherein:
each of said at least one infrared detecting device comprises a long wavelength infrared (LWIR) digital camera;
said bubbles introduced by said soap bubbles into the fluid flow have a predetermined size and temperature so that they last for a predetermined time while entrained in said flow; and
a focal length and aperture size of said LWIR maintains the bubbles in focus and in view over a predetermined linear distance within the flow field.

21. The system of claim 20, wherein said bubble are soap bubbles comprising a film of water and a surfactant enclosing a volume filled with a gaseous mixture causing the bubbles to have a rising/settling rate in said atmospheric air that makes them buoyant over said linear distance for a predetermined time.

22. The system of claim 21, wherein a parameter ρ̅ represents the ratio of the density ρ_{b} of said bubbles to the density ρₐₐ of the ambient air in said fluid flow (ρ̅=ρ_{b}/βₐₐ) and |ρ̅−1|≤10%.

23. The system of claim 20, wherein said predetermined distance is between 10 m and 200 m.

24. The system of claim 20, wherein:
said LWIR camera has an imaging sensor comprising a two-dimensional field of temperature sensing pixels having a resolution of at least 640×512; and
said bubbles are introduced to the flow field at a rate designed to produce a bubble density up to 200 bubbles per 32×32 pixels of said temperature-sensing pixel field.

25. The system of claim 20, further comprising a plurality of said LWIR cameras.
